(19) United States
(12) Patent Application Publication
(10) Pub. No.: US 2015/0065662 A1
(43) Pub. Date: Mar. 5, 2015

(54) CURING AGENT COMPOSITIONS FOR CONDENSATION-CROSSLINKING RTV-2 SYSTEMS

(71) Applicant: Wacker Chemie AG, Munich (DE)

(72) Inventor: Wolfgang Ziche, Burghausen (DE)

(21) Appl. No.: 14/394,282

(22) PCT Filed: Apr. 5, 2013
(86) PCT No.: PCT/EP2013/057226

§ 371 Date: Oct. 14, 2014

(30) Foreign Application Priority Data
Apr. 19, 2012 (DE) 10 2012 206 489.3

(51) Int. Cl. C08G 77/38

(52) U.S. Cl. CPC C08G 77/38
USPC 525/474; 252/183.11

(57) ABSTRACT

Hardener compositions for condensation-crosslinking RTV-2 systems free of organotin compounds contain a catalyst selected from among compounds of titanium, cerium, zirconium, molybdenum, manganese, copper, zinc, bismuth, lithium, strontium, or boron, and at least one aminoalkyl alcohol reinforcing the effectiveness of the catalyst.

### CROSS REFERENCE TO RELATED APPLICATIONS

This application is the U.S. National Phase of PCT Appln. No. PCT/EP2013/057226 filed Apr. 5, 2013, which claims priority to German Application No. 10 2012 206 489.3 filed Apr. 19, 2012, the disclosures of which are incorporated in their entirety by reference herein.

### BACKGROUND OF THE INVENTION

1. Field of the Invention

The invention relates to hardener compositions H for condensation-crosslinking RTV-2 systems which comprise an aminoalkyl alcohol, and to RTV-2 systems.

2. Description of the Related Art

Two-component (2C) silane-curing compositions in which polymers having hydrolyzable silyl groups or silanol groups are crosslinked by silicon compounds having hydrolyzable groups have been known for quite some time in the prior art, and are often used as adhesives and sealants in various applications.

Two-component systems that crosslink at room temperature are called “room temperature vulcanizing 2 part” systems (RTV-2). One of the two components is often referred to as a polymer composition or component A. The second component is often called a hardener composition or component B.

Organotin compounds are extremely effective as a catalytically active constituent, but use of these is increasingly undesirable because of their toxicological properties.

Alternative catalyst systems as described, for example, in US 2011/0009558 are either not obtainable commercially or require complicated production, and are also less effective than organotin compounds in RTV-2 systems.

### SUMMARY OF THE INVENTION

It has now been unexpectedly and surprisingly discovered that hardener compositions for condensation-crosslinking RTV-2 systems can contain an effective catalyst, which is free of organotin compounds; the catalyst being selected from compounds of titanium, cerium, zirconium, molybdenum, manganese, copper, zinc, bismuth, lithium, strontium, or boron.

### DETAILED DESCRIPTION OF THE PREFERRED EMBODIMENTS

The invention provides hardener compositions H for condensation-crosslinking RTV-2 systems comprising
(A) at least one crosslinking agent having hydrolyzable groups bonded to silicon atoms,
(B) at least one catalyst selected from compounds of titanium, cerium, zirconium, molybdenum, manganese, copper, zinc, bismuth, lithium, strontium, or boron, and
(C) at least one aminoalkyl alcohol.

The hardener compositions H provide effective hardening in RTV-2 systems. The aminoalkyl alcohol (C) reinforces the effectiveness of the catalyst (B). The hardener compositions comprise no organotin compounds. 2C silane-curing compositions can easily be formulated with the hardener compositions H.

The crosslinking agents (A) are preferably organosilicon compounds of the general formula (I)

ZₐSiR¹₍₄₋ₐ₎ (I),

where
R¹ can each independently be identical or different and are monovalent, optionally substituted hydrocarbon moieties which can be interrupted by nonadjacent heteroatoms selected from oxygen atoms and nitrogen atoms,
Z can each independently be identical or different and are hydrolyzable moieties, and
a is 3 or 4,
   or partial hydrolyzates thereof.

The partial hydrolyzates can be partial homohydrolyzates, i.e. partial hydrolyzates of one type of an organosilicon compound of the general formula (I) or partial cohydrolyzates, i.e. partial hydrolyzates of at least two different types of organosilicon compounds of the general formula (I). The weight-average Mw of these crosslinking agents and, especially, partial hydrolyzates, is preferably at most 1,200 g/mol.

Although the general formula (I) does not show it, these organosilicon compounds can comprise a small proportion of hydroxy groups resulting from the production process, preferably up to at most 5% of all of the Si-bonded moieties. If the crosslinking agents (A) are partial hydrolyzates of organosilicon compounds of the general formula (I), preference is given to those having up to 10 silicon atoms.

It is preferable that moiety R¹ is a monovalent hydrocarbon moiety having 1 to 18 carbon atoms, optionally substituted by halogen atoms, amino groups, ether groups, ester groups, epoxy groups, mercapto groups, cyano groups, or (poly)glycol moieties, where the latter are preferably composed of oxyethylene and/or oxypropylene units, and it is particularly preferable that R¹ is an alkyl moiety having 1 to 12, in particular 1 to 6, carbon atoms, in particular the methyl moiety. It is also possible, however, that moiety R¹ is a divalent moiety bonding, for example, two silyl groups to one another.

Examples of moieties R¹ are alkyl moieties, for example, the methyl, ethyl, n-propyl, isopropyl, 1-n-butyl, 2-n-butyl, isobutyl, tert-butyl, n-pentyl, isopentyl, neopentyl, or tert-pentyl moiety; hexyl moieties, for example, the n-hexyl moiety; heptyl moieties, for example, the n-heptyl moiety; octyl moieties, for example, the n-octyl; and isooctyl moieties, for example, the 2,2,4-trimethylpentyl moiety; nonyl moieties, for example, the n-nonyl moiety; decyl moieties, for example, the n-decyl moiety; dodecyl moieties, for example, the n-dodecyl moiety; octadecyl moieties, for example, the n-octadecyl moiety; cycloalkyl moieties, for example, the cyclopentyl, cyclohexyl, cycloheptyl moiety or methylcyclohexyl moieties; alkenyl moieties, for example, the vinyl, 1-propenyl, or 2-propenyl moiety; aryl moieties, for example, the phenyl, naphthyl, anthryl, or phenanthryl moiety; alkaryl moieties, for example o-, m-, or p-tolyl moieties; xylyl moieties and ethylphenyl moieties; and aralkyl moieties, for example the benzyl moiety, the alpha- and beta-phenylethyl moiety.

Examples of substituted moieties R¹ are methoxyethyl, ethoxyethyl, ethoxyethoxyethyl moiety, and the 2-aminoethylamino moiety.

Examples of divalent moieties R¹ are polyisobutylenediyl moieties and propanediyl-terminated polypropylene glycol moieties.

Hydrocarbon moieties having 1 to 12 carbon atoms are preferred for moiety R¹, and particular preference is given to the methyl moiety and the vinyl moiety.

Examples of Z are all of the hydrolyzable moieties disclosed hitherto, for example optionally substituted hydrocarbon moieties bonded via oxygen or nitrogen to silicon.

It is preferable that moiety Z is moiety —OR², where R² is a substituted or unsubstituted hydrocarbon moiety which can be uninterrupted by oxygen. Examples of Z are methoxy, ethoxy, n-propoxy-, isopropoxy, n-butoxy, isobutoxy, sec-butoxy, tert-butoxy, and 2-methoxyethoxy moiety; amino moieties, for example, methylamino, dimethylamino, ethylamino, diethylamino, and cyclohexylamino moiety; amido moieties, for example, N-methylacetamido and benzamido moiety; aminoxy moieties, for example, the diethylaminoxy moiety; oximo moieties, for example dimethylketoximo, methylethylketoximo, and methylisobutylketoximo moiety; enoxy moieties, for example the 2-propenoxy moiety; and acyloxy moieties, for example, acetyl groups.

Preferably, the crosslinking agents (A) are tetramethoxysilane, tetraethoxysilane, tetrapropoxysilane, tetrabutoxysilane, methyltrimethoxysilane, methyltriethoxysilane, vinyltrimethoxysilane, vinyltriethoxysilane, phenyltrimethoxysilane, phenyltriethoxysilane, 1,2-bis(trimethoxysilyl)ethane, 1,2-bis(triethoxysilyl)ethane, or else partial hydrolyzates of the organosilicon compounds mentioned, for example, hexaethoxydisiloxane.

More preferably, the crosslinking agents (A) are tetramethoxysilane, tetraethoxysilane, tetrapropoxysilane, methyltrimethoxysilane, methyltriethoxysilane, vinyltrimethoxysilane, vinyltriethoxysilane, phenyltrimethoxysilane, 1,2-bis(trimethoxysilyl)ethane, 1,2-bis(triethoxysilyl)ethane, or partial hydrolyzates of these. Most Preferably, the crosslinking agents (A) are tetraethoxysilane, 1,2-bis(triethoxysilyl)ethane, vinyltriethoxysilane, or partial hydrolyzates or cohydrolyzates of these. The crosslinking agents (A) are preferably commercially available products or can be produced by conventional methods in silicon chemistry. Quantities of the crosslinking agents (A) are preferably such as to give an at least twofold molar excess of hydrolyzable or hydrolyzed crosslinking agent functions, based on the end group content of the constituents requiring crosslinking. It is preferable that the molar ratio of crosslinking agent functions to the groups requiring crosslinking is adjusted to a value from 2:1 to 10:1.

Suitable catalysts (B) are catalysts for the condensation reaction, for example, compounds of titanium such as organotitanates or chelate complexes, cerium compounds, zirconium compounds, molybdenum compounds, manganese compounds, copper compounds, or zinc compounds or their salts, alkoxylates, chelate complexes, or catalytically active compounds of the main groups or salts of bismuth, lithium, strontium, or boron.

Preference is given, as catalyst (B), to the metal compounds of cerium, zirconium, bismuth, and lithium. Particular preference is given to their alkoxylates and carboxylates.

It is preferable that the aminoalkyl alcohol component (C) is a compound of the general formula (II)

R³R⁴N—R⁵—OH (II),

where
R³ and R⁴ represent each independently hydrogen or comply with the definitions and preferred definitions of R¹, and
R⁵ represents a divalent alkyl moiety having 2 to 12 carbon atoms which can be interrupted by heteroatoms selected from oxygen, nitrogen, and sulfur, or may be substituted by amino groups, hydroxy groups, or alkoxy groups.

Preferably, moiety R⁵ is a divalent alkyl moiety having 2 to 6 carbon atoms. The amino groups on the moiety R⁵ preferably have hydrogen atoms or alkyl moieties having 1 to 6 carbon atoms as substituents. The alkoxy groups on the moiety R⁵ preferably have alkyl moieties having 1 to 6 carbon atoms.

The hardener compositions H preferably comprise 1 to 500 parts by weight, more preferably 5 to 200 parts by weight, most preferably 10 to 80 parts by weight, of catalyst (B) for every 100 parts by weight of crosslinking agents (A).

The hardener compositions H preferably comprise 0.5 to 300 parts by weight, more preferably 2 to 100 parts by weight, most preferably 5 to 40 parts by weight, of aminoalkyl alcohol (C) for every 100 parts by weight of crosslinking agents (A).

The invention further provides RTV-2 systems, which comprise the hardener compositions H and moisture-curable silyl-functional polymers (D), which have silyl groups of the general formula (III)

-L[-SiR⁶_{2-b}X_{b}—O]ₙ—SiR⁶_{3-c}X_{c} (III),
where
   L represents a divalent organic group,
   X each independently represents a hydrolyzable group,
   R⁶ represents a hydrocarbon moiety,
   b is 0, 1, or 2,
   c is 0, 1, 2, or 3,
   b+c is at least 1, and
   n is an integer from 0 to 16.

The hardener composition H is used in RTV-2 systems together with a second component. The RTV-2 systems have been known for a long time to those skilled in the art. RTV-2 silicone systems usually comprise hydroxy-terminated polydimethylsiloxanes as crosslinkable polymers, optionally water, and mostly trimethylsilyl-terminated polydimethylsiloxanes as a plasticizer component.

If moisture-curable silane-functional polymers (D) are used in the hardener component, the second component comprises water, which is required for the hardening process and may be in the form of moist fillers or hydrates, and optionally plasticizers compatible with the polymer basis of the polymers (D).

Examples of L are divalent hydrocarbon moieties having 1 to 20, in particular 1 to 6, carbon atoms, for example, ethylene, propylene, butylene, or hexylene moieties.

Examples of X are alkoxy moieties, in particular alkoxy moities having 1 to 6 carbon atoms, and hydroxy moieties.

Examples of R⁶ are alkyl moieties having 1 to 20 carbon atoms, aryl moieties having 1 to 20 carbon atoms, or aralkyl moieties having 7 to 20 carbon atoms, and preferably the alkyl moieties mentioned as preferred for R¹.

The main chain of the polymers (D) can widely vary: it is possible, as in WO 2010/111174 A, equivalent to US 2012/009366, to prefer use of polymers with low permeability, polyester-, polyether-, and polyurethane-based polymers (D) described in WO 2009/064428 A, equivalent to U.S. Pat. No. 7,781,513, and in WO 2008153392 A, equivalent to US 2010/197855. Preferably, the main chain of the silyl-functional polymers (D) consists of polymers selected from polyester, polyether, polyurethane, and polyorganosiloxane.

Preferably, the main chain of the polymers (D) comprises at least 80% by weight of polyorganosiloxane, and more preferably, the main chain of the polymers (D) consists of polyorganosiloxane, most preferably of polydimethylsiloxane.

The viscosity of the polymers (D) at 25° C. is preferably from 100 to 350,000 mPa·s, more preferably from 200 to 200,000 mPa·s, most preferably from 500 to 80,000 mPa·s.

The RTV-2 systems comprise such quantities of catalyst (B) that are conventional for the condensation reaction, preferably from 50 to 5,000 ppm, based in each case on the metal, for example, in case of lithium compounds from 100 to 1,000 ppm, and in the case of bismuth compounds from 2,000 to 5,000 ppm, based in each case on the metal and the weight of the RTV-2 systems.

The RTV-2 systems can comprise adhesion promoters (E) as further components. They are regarded as functional silanes or coupling agents. Examples of the adhesion promoters (E) are silanes and organopolysiloxanes having functional groups, for example, those having glycidoxy, amino, or methacryloxy moieties. Other compounds that can be used as adhesion promoters (E) are silanes having hydrolyzable groups and having SiC-bonded vinyl-, acryloxy-, methacryloxy-, epoxy-, anhydride-, acid-, ester-, cyanurato-, carbamato-, or ureido-functional, or ether groups, and also their partial hydrolyzates and cohydrolyzates. Preferably, adhesion promoters are amino-, acrylic-, epoxy-, cyanurato-, carbamato-, or ureido-functional silanes having hydrolyzable groups, and partial hydrolyzates of these. Quantities of (E) present in the RTV-2 systems are preferably such that 100 parts by weight of the catalyzed, ready-to-use RTV-2 mixture comprise up to 50 parts by weight, more preferably 0.1 to 20 parts by weight, most preferably 0.5 to 10 parts by weight, of (E).

The RTV-2 systems can comprise other suitable constituents (F). Examples of (F) that can be used in the RTV-2 systems are fillers, for example, reinforcing and nonreinforcing fillers such as silica, carbon black, quartz, chalk, or diatomaceous earth. Other examples of (F) are plasticizers, soluble dyes, inorganic and organic pigments, solvents, fungicides, fragrances, dispersing agents, additives to optimize rheology, corrosion inhibitors, oxidation inhibitors, light stabilizers, heat stabilizers, flame retardants, and agents for influencing electrical properties.

The hardener composition H can be, for example, produced by mixing of the individual components (A), (B), and (C). The other components (D), (E), and (F) are likewise incorporated into the mixture if necessary.

The hardener composition H is used as a component in condensation-crosslinking RTV-2 compositions. These condensation-crosslinking RTV-2 compositions are in turn used, for example, as adhesives and sealants in various applications.

In the above formulae, the definitions apply mutually independently to each of the above symbols. The silicon atom is tetravalent in all of the formulae.

In the examples below, unless otherwise stated in any particular case, all quantitative data and percentage data are based on weight, all pressures are 0.10 MPa (abs.), and all temperatures are 20° C. Viscosities were measured at 25° C.

### Example 1

4 g of Borchi® Kat 24 (bismuth(III) neodecanoate from OMG Borchers GmbH, 40764 Langenfeld, Germany) and 1.33 g of 2-{[2-(dimethylamino)ethyl]methylamino}ethanol are heated to 150° C. for 1 h. The mixture is clear and viscous. 0.05 g of a nonionically formulated oil-in-water emulsion of a polydimethylsiloxane of moderate viscosity (50% of water) is mixed into 50 g of a silanol-terminated polydimethylsiloxane (viscosity 1,000 mPa·s). 0.5 g of the Borchi® Kat solution is added to the mixture. The consistency of the mixture does not change in 24 h. 1 g of WACKER® SILIKAT TES 40 WN (tetraethoxysilane from Wacker Chemie AG, Germany) is stirred into the mixture. After 2 h, the mixture is thoroughly vulcanized.

### Example 2

2 g of Borchi® Kat 24 and 1.33 g of 2-{[2-(dimethylamino)ethyl]methylamino}ethanol are heated to 130° C. for 1 h. The mixture is clear and viscous, and is studied by means of IR spectroscopy: no amide formation or ester formation is observed, and the spectrum corresponds to the superimposition of the two individual components. 0.05 g of a nonionically formulated oil-in-water emulsion of a polydimethylsiloxane of moderate viscosity (50% of water) is mixed into 50 g of a silanol-terminated polydimethylsiloxane (viscosity 1,000 mPa·s). 0.5 g of the Borchi® Kat solution is added to the mixture. 1 g of WACKER® SILIKAT TES 40 WN is stirred into the mixture. A rheometer is used to follow the vulcanization process (Anton Paar MCR301 with PP25-SN single-measurement system; [d=0.5 mm], frequency 1 Hz, deformation 10%). tan δ=1 was achieved after 100 min.

### Example 3

### Not of the Invention

0.05 g of a nonionically formulated oil-in-water emulsion of a polydimethylsiloxane of moderate viscosity (50% of water) is mixed into 50 g of a silanol-terminated polydimethylsiloxane (viscosity 1,000 mPa·s). 0.5 g of Borchi® Kat 24 is added to the mixture. 1 g of WACKER® SILIKAT TES 40 WN is stirred into the mixture. A rheometer is used to follow the vulcanization process (Anton Paar MCR301 with PP25-SN single-measurement system; [d=0.5 mm], frequency 1 Hz, deformation 10%). tan δ=1 was achieved after 390 min.

In comparison Example 1 illustrates efficiency of the hardener of the invention, which provides for considerably faster vulcanization with only 60% of the catalyst.

### Example 4

4 g of Borchi® Kat 24 and 1.33 g of 2-(diethylamino)ethanol are heated to 130° C. for 1 h. The mixture is clear and viscous. 0.05 g of a nonionically formulated oil-in-water emulsion of a polydimethylsiloxane of moderate viscosity (50% of water) is mixed into 50 g of a silanol-terminated polydimethylsiloxane (viscosity 1,000 mPa·s). 0.5 g of the Borchi® Kat solution is added to the mixture. 1 g of WACKER® SILIKAT TES 40 WN is stirred into the mixture. After 2 h, the composition has gelled.

### Example 5

4.65 g of Borchi® Kat 24 (OMG Borchers GmbH, 40764 Langenfeld, Germany) and 2.08 g of N-(2-hydroxyethyl)ethylenediamine are heated to 130° C. for 1 h. The mixture is clear and viscous. 0.05 g of a nonionically formulated oil-in-water emulsion of a polydimethylsiloxane of moderate viscosity (50% of water), 2.5 g of Wacker HDK® V15, 0.5 g of Geniosil® GF91 (N-(2-aminoethyl)-3-aminopropyltrimethoxysilane from Wacker Chemie AG) is mixed into 50 g of a silanol-terminated polydimethylsiloxane (viscosity 1,000 mPa·s). 0.5 g of the Borchi® Kat solution and 1 g of WACKER® SILIKAT TES 40 are stirred into this mixture. After 30 min, the composition has gelled, and after 50 min the composition can be removed from the polyethylene mold.

### Example 6

4.65 g of Borchi® Kat 24 and 5.85 g of 2-{[2-(dimethylamino)ethyl]methylamino}ethanol are heated to 130° C. for 1 h. 7.3 g of this mixture are mixed with 29.2 g of a polydimethylsiloxane (viscosity 20 Pas) and 14.6 g of a polydimethylsiloxane (viscosity 100 mPas), and 16.8 g of bis(triethoxysilylethane) and 8 g of Geniosil® GF 91 (Wacker Chemie AG) and 5 g of HDK V15 (fumed silica from Wacker Chemie AG), providing a hardener composition of the invention. 10 parts by weight Elastosil® RT 774 (consisting essentially of a silanol-terminated polydimethylsiloxane, a trimethylsilyl-terminated polydimethylsiloxane, water, and fillers) are mixed with 1 part by weight of the hardener composition. Pot life is 10 minutes.

A rheometer is used to follow the vulcanization process (Anton Paar MCR301 with PP25-SN single-measurement system; [d=0.5 mm], frequency 1 Hz, deformation 10%). tan δ=1 was achieved after 20 min.

The Elastosil® RT 774/hardener mixture is spread to a thickness of 2 mm. 4 weeks after the hardening process, S2 test samples were punched and tested in accordance with DIN 53505 and 53504.

For comparison, the values are stated for the analogously produced vulcanizate made of 10 parts by weight of Elastosil® RT 774 and 1 part by weight of the commercially available catalyst T77 (Wacker Chemie AG).

| | | 100% | Ultimate tensile | Elongation at |
|---|---|---|---|---|
| | Shore A | modulus | strength [N/mm²] | break [%] |
| Example 5 | 40 | 0.96 | 1.3 | 152 |
| RT 774/ | 38 | 1.16 | 1.6 | 157 |
| T77* | | | | |

*not of the invention

### Example 7

4.65 g of Borchi® Kat 24 and 5.85 g of 2-{[2-(dimethylamino)ethyl]methylamino}ethanol are stirred for 5 min at 23° C. 7.3 g of this mixture are mixed with 29.2 g of a polydimethylsiloxane (viscosity 20 Pas) and 14.6 g of a polydimethylsiloxane (viscosity 100 mPas), and 16.8 g of WACKER SILIKAT TES 40 and 8 g of Geniosil® GF 91 (Wacker Chemie AG), and 5 g of HDK V15 (Wacker Chemie AG), providing a hardener composition H of the invention.

10 parts by weight of Elastosil® RT 774 are mixed with 1 part by weight of the hardener. The Elastosil® RT 774/hardener mixture is spread to a thickness of 2 mm. Pot life is 15 min. 4 weeks after the hardening process, S2 test samples were punched and tested in accordance with DIN 53505 and 53504.

| | | 100% | Ultimate tensile | Elongation at |
|---|---|---|---|---|
| | Shore A | modulus | strength [N/mm2] | break [%] |
| Inventive | 25 | 0.58 | 1.6 | 407 |
| Example 7 | | | | |

### Comparative Example 8

### Not According to the Invention

7 g of Borchi® Kat 24 (bismuth(III) neodecanoate from OMG Borchers GmbH, 40764 Langenfeld, Germany) and 7 g of tetramethylethylenediamine are heated to 130° C. for 1 h. The mixture is clear and viscous.

7.3 g of this mixture are mixed with 29.2 g of a polydimethylsiloxane (viscosity 20 Pas) and 14.6 of a polydimethylsiloxane (viscosity 100 mPas), and 16.8 g of bis(triethoxysilylethane), and 8 g of Geniosil® GF 91 (Wacker Chemie AG) to give a hardener, not according to the invention.

10 parts by weight of Elastosil® RT 774 are mixed with 1 part by weight of the hardener. Pot life is more than 5 hours. Use of amino alcohols is revealed to be essential.

1.-8. (canceled)

9. A hardener composition for condensation-crosslinking RTV-2 systems comprising:
(A) at least one crosslinking agent having at least one hydrolyzable group bonded to silicon,
(B) at least one compound of titanium, cerium, zirconium, molybdenum, manganese, copper, zinc, bismuth, lithium, strontium, or boron as a catalyst, and
(C) at least one aminoalkyl alcohol.

10. The hardener composition of claim 9, wherein the at least one crosslinking agent (A) is an organosilicon compound of the formula (I)
ZₐSiR¹₍₄₋ₐ₎ (I),
where
R¹ represent optionally substituted hydrocarbon moieties, optionally interrupted by nonadjacent heteroatoms selected from the group consisting of oxygen, nitrogen, and sulfur,
Z represents hydrolyzable moieties, and
a is 3 or 4,
or is a partial hydrolyzate of the organosilicon compound (I).

11. The hardener composition of claim 9, wherein the at least one catalyst (B) is an alkoxylate or a carboxylate of cerium, zirconium, bismuth, or lithium.

12. The hardener composition of claim 9, wherein the at least one aminoalkyl alcohol (C) corresponds to the formula (II)
R³R⁴N—R⁵—OH (II),
where
R³ and R⁴ represent hydrogen or optionally substituted hydrocarbon moieties, optionally interrupted by nonadjacent oxygen atoms, and
R⁵ represents a divalent alkyl moiety having 2 to 12 carbon atoms, optionally interrupted by nonadjacent heteroatoms selected from oxygen, nitrogen, and sulfur, and optionally substituted by amino groups, hydroxy groups, or alkoxy groups.

13. The hardener composition of claim 9, wherein 1 to 500 parts by weight of the at least one catalyst (B) are present for every 100 parts by weight of crosslinking agent(s) (A).

14. The hardener composition H of claim 9, wherein 0.5 to 300 parts by weight of the at least one aminoalkyl alcohol (C) are present for every 100 parts by weight of crosslinking agent(s) (A).

15. An RTV-2 system comprising a hardener composition of claim 9 and at least one moisture-curable silyl-functional polymer (D) which has silyl groups of the formula (III)
-L[-SiR⁶_{2-b}X_{b}—O]ₙ—SiR⁶_{3-c}X_{c} (III),
where
L represents a divalent organic group,
X each independently represents a hydrolyzable group,
R⁶ represents a hydrocarbon moiety,
b is 0, 1, or 2,
c is 0, 1, 2, or 3,
b+c is at least 1, and
n is an integer from 0 to 16.

16. The RTV-2 system of claim 15, wherein a main chain of the at least one silyl-functional polymer (D) is a polyester, polyether, polyurethane, or polyorganosiloxane polymer.
